(19) United States
(12) Patent Application Publication
(10) Pub. No.: US 2008/0146339 A1
(43) Pub. Date: Jun. 19, 2008

(54) Massive Multiplayer Online Sports Teams and Events

(76) Inventors: Arlen Lynn Olsen, Clifton Park, NY (US); Jonathan Michael Madsen, Rexford, NY (US)

Correspondence Address: SCHMEISER, OLSEN & WATTS, 22 CENTURY HILL DRIVE, SUITE 302, LATHAM, NY, 12110, US

(21) Appl. No.: 11/610,969

(22) Filed: Dec. 14, 2006

(51) Int. Cl. G06F 17/00

(52) U.S. Cl. 463/42

(57) ABSTRACT

The invention disclosed is a massive multiplayer online game or event. An online server is connected to the world wide web. A first remote having a first sensor to detect movement and orientation of a first user, wherein first data signals are communicated from said sensor to the online server; and a second remote having a second sensor to detect movement and orientation of a second user, wherein data signals are communicated from said sensor to the online server are used. A machine readable program with the rules of a game or event thereon to coordinate the first data signals and the second data signals in accordance with the game.

### FIELD OF THE INVENTION

This invention relates to Massive Multiplayer online games.

### BACKGROUND OF THE INVENTION

A Massively Multiplayer Online Game (MMOG or MMO) is a computer game which is capable of supporting hundreds or thousands of players simultaneously, and is played on the Internet. Typically, this type of game is played in a giant persistent world.

MMOs can enable players to compete with and against each other on a grand scale, and sometimes to interact meaningfully with people around the world. Most MMOs require players to invest large amounts of their time into the game. Many MMOs can be played for free on the internet such as: Runescape, Adventure Quest, Silkroad Online and Renaissance Kingdoms.

### SUMMARY OF THE INVENTION

A first aspect of the invention includes a massive multiplayer online game or event comprising: an online server connected to the world wide web; a first remote having a first sensor to detect movement and orientation of a first user, wherein first data signals are communicated from said sensor to the online server; a second remote having a second sensor to detect movement and orientation of a second user, wherein data signals are communicated from said sensor to the online server; and a machine readable program with the rules of a game or event thereon to coordinate the first data signals and the second data signals in accordance with the game.

A second aspect of the invention includes A massive multiplayer online game or event comprising: connecting at least 100 users to an online server connected to the world wide web; providing a remote having a first sensor to detect movement and orientation of a first user, wherein first data signals are communicated from said sensor to the online server; providing a remote having a second sensor to detect movement and orientation of a second user, wherein data signals are communicated from said sensor to the online server; providing a rules of a game or event thereon to coordinate the first data signals and the second data signals in accordance with the rules of a game or event; and competing, using physical skills, between the first and second user to generate the first data signals and second data signals to arrive at an outcome based on the rules of the game or event.

### BRIEF DESCRIPTION OF THE DRAWING

Some of the embodiments of this invention will be described in detail, with reference to the following figures, wherein like designations denote like members, wherein:

FIG. 1 is a diagram of an embodiment of the present invention;

FIG. 2 is an embodiment of a view of a MMOSTE event.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

This invention is a MMOSTE (Massive Multiplayer Online Sports Teams and Events). The technology may involve a computer game which is capable of supporting hundreds or thousands of players simultaneously, and is played on the Internet using actual physical actions of the players as if actually competing in a sports tournament or event. It allows people from around the world to compete on sports teams or in individual sports tournaments or events. Individuals or teams may become superstars in a virtual world in team sports and events in stadiums, arenas and venues such as boxing, lacrosse, downhill skiing, tennis, table tennis, track events, sports car driving, golf, karate, ultimate fighting, diving, ballet, motocross, soccer, basketball, baseball, wrestling, gladiator sports, air sports (hang-gliding, helicopter, airplane), space sports (space-walking, spaceship racing), American football, badminton, Canadian football, cricket, curling, cycling, road bicycle racing, mountain bike racing, BMX, motor-cycle street-bike racing, monster-truck racing, roller-blading, ice-skating, snowboarding, snow-mobile racing, field Hockey, thoroughbred Horse racing, skateboarding, ice hockey, lacrosse, box/indoor lacrosse, mixed martial arts, rugby league, shooting, archery, swimming, scuba-diving, boating, water-skiing, triathlon or any other sports team or event such as any Olympic sporting event.

Individuals may purchase virtual sports equipment using either virtual world dollars through tournaments or use real world dollars to upgrade their abilities in a quicker manner. Players will be classified in categories such as novice, amateurs and professionals based upon experience. Players can be sponsored by corporations that would like their name attached to the teams. Individuals could also purchase teams and property holdings such as stadiums, trademarks, etc. They can have team owners, agents free agency, player contracts (virtual or real). Players can take on characteristics of real life athletes based on win percentage, speed agility, etc. Players can download available playbooks, modify playbooks, or generate their own playbooks.

Players may access and acquire cheat functionalities allowing them to expand performance capabilities. For example, certain cheat functions may allow players to jump higher and longer, move faster, contact balls and other objects with greater accuracy, swing harder, etc. In some events, various players may compete against each other using cheat-mode functionality such that various actions of some players affected by cheat functionality may be countered by various actions of other players also affected by cheat functionality. In this sense, the cheat functionality may become a competitive advantage or disadvantage to be utilized by and against any or all competing players. However, various parameters and rules may be provided to proscribe any cheating capability by any player participating in various MMOSTE happenings. For instance, where a player is participating in an event having typical player activity and/or competing against other players having similar player activity, cheating may be prohibited so that player movement and functionality is directed purely under parameters related to common player remote control devices utilizing physical movement to direct online participation by players. Protocols may be provided to alert players when cheating functionality is or is attempting to be used. Moreover, parameters and rules may provide for discipline or sanctions against players who inappropriately use cheat functionality. Such discipline may include temporary or complete loss of play privileges, fines related to virtual or real dollars, or diminishment of player skill set. Player parameters and rules may be provided under contract by owners, other players, MMOSTE operators, governments, ISP's, team captains, managers, programmers, companies, sponsors, corporations or other entities or combinations of entities. Player agreements may be in the form of click-wrap agreements, shrink-wrap agreements, standard paper contracts or other binding agreements.

Teams may be comprised of multiple players, wherein the players may be under contract to play and participate in particular MMOSTE happenings. Accordingly, players may incur liability for failure to meet contractual terms. Player contracts may be comprised of agreements similar to contracts for real world athletes or event participants and may be tailored to operate according to and secure rights in MMOSTE participation. However, MMOSTE players may also play and participate in an online world under no contractual obligations. In addition, teams may be included in various leagues, such as professional leagues, minor leagues (farming players to professional teams), and amateurs leagues. Furthermore, the various leagues may be formed according to, or include divisions according to, geography, age, gender, nationality, sponsorship make-up, online availability, government censored category, financial capital, time logged in the world, time logged playing, or other like categories. Moreover, a single individual may identify with and control multiple online players. For instance, a person may be a have one online identity as a professional golfer, another online identity as an amateur soccer player, and yet another online identity as a novice motocross rider; there may be no limit to the number of players a single individual may control. Still further, various embodiments may provide for multiple individuals using physical movement to combine or aggregate the movement into the online actions of a single player. For example, one individual may control the lower portion (legs and feet) of a tennis player, while another individual may control the upper portions (torso, arms, hands, head) of the same tennis player; or one person may control the feet of an airplane pilot player, while another person could control hand movement of the same airplane pilot player. Hence, there may be a plurality of individuals providing real world physical movement to conglomerate the online actions of a single player.

One individual may control multiple players on a team or participating in an event. For example, the one individual may simultaneously wield multiple remotes (such as by holding one remote in a right hand and one remote in a left hand) to control multiple players at the same time. Moreover, one individual may control several players with a single remote by toggling between various players. For instance, the individual my control a quarterback by maneuvering the remote to control and direct a throw and pass of the virtual football. Then while the ball is in the air, the individual may toggle to a receiver and then use the remote to catch the thrown pass Players that reach professional status may compete in tournaments that may have advertising sold at the tournament to companies. The companies may be virtual corporations with virtual holdings controlled by real world people or entities. Moreover, the corporations may be real world corporations that buy virtual advertising space. Individuals may pay virtual or real monies to enter portions of the MMOSTE world to be a spectator of a game or event played by other participants. Once virtual entrance is granted through payment, the spectator may have capability to view the game or event from a viewpoint, or from various other view points. Furthermore, the spectator may review event participation in instant replay. However, rules, protocol and parameters may be provided to prohibit a spectator from interfering with the athletic game or other event that is being viewed. Spectators may opt to be cheerleaders or sports broadcasters. In addition, individuals may pay using virtual or real dollars to enter the sporting event and wager as participants or spectators. For example, Player A may have a skill set of Professional and a $1,000.00 in virtual dollars which may have a 100 to 1 exchange rate ($10.00 real dollars). He must pay $100.00 virtual dollars to enter a professional MMOSTE golf tournament ($1.00), but based on wagering, advertisers and sponsors the payout may be $5,000.00 for winning the tournament. Certain areas of the world may require payment to be a spectator which may also increase the winnings purse.

Current MMOs (Massive Multiplayer Onlines) can enable players to compete with and against each other on a grand scale, and sometimes to interact meaningfully with people around the world. The MMOSTE is different in that it requires a certain amount of skill in the physical world by using a remote similar to the Remote made and/or distributed by Nintendo®. The Remote may be able to sense movement and orientation. Accelerometers in the Remote may allow it to sense linear motion along three axes, as well as tilt. The controller features an optical sensor, allowing it to determine where it is pointing. In addition, the remote may comprise gyroscopes to help provide orientation and other ultra-sonic, sonic, and/or electromagnetic sensors facilitating three-dimensional position, direction, and movement. Various remote configurations and functionality may be provided. For example a remote may include microphones, speakers, lights, and movable components, enabling it to receive audio inputs, make noises, shine, glow, shake, rumble, vibrate, and/or have other user interactive functionality. Furthermore, a remote may be operable with multiple input devices. For instance, as steering wheel-type remote may simultaneously operate with a foot pedal or series of foot pedals inputs (such as a gas pedal, clutch pedal, and/or brake pedal) that may be communicatively linked to provide response similar to driving a vehicle. Moreover, a remote may operate with additional remotes or inputs devices such as rotatable structures (like bicycle pedals, or pulley systems) that may be utilized to generate inputs for simulating bike riding propulsive force, pulling of bow-strings, or swimming movements. Furthermore, a remote may be operable with floor sensors configured to detect when a person places a foot or other body part onto a floor portion having a sensor. Hence, such remote incorporations may be used to detect running, walking, hopping, dancing, jumping or other movements. Remotes may be configured to take on physical shape and appearance of real world objects. For example, a remote may be shaped like a gun, a sword, a tennis racquet, a snow-ski, a joy-stick, a steering wheel, a ball, a boxing glove, a baseball mitt, a scuba fin, a pen, a pencil, a paint brush, or any other shaped object having some real-world dimension.

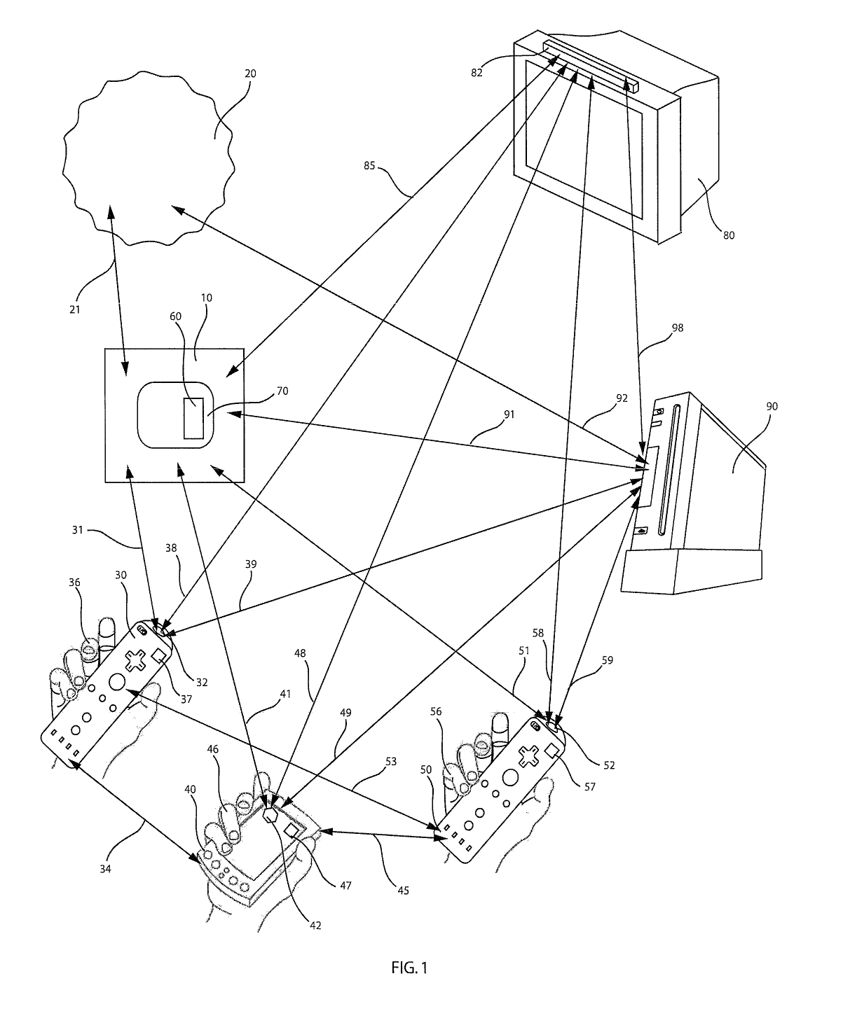

Referring to FIG. 1 is shown an online server 10 attached to the world wide web 20. Communications 21 between online server 10 and world wide web 20 may be had. A first remote 30, second remote 40, and third remote 50 having a first sensor 32, a second sensor 42, and a third sensor 52 are shown which are controlled by a first 36, second 46 and third 56 user. The remotes 30, 40, 50 may have a first accelerometer 37, second accelerometer 47 and third accelerometer 57 to detect movement and orientation. First 31/34/38/39, second 41/45/48/49 and third 51/53/58/59 data signals may be transmitted from the remotes 30, 40, 50 through any known optical signal (such as LED—Light Emitting Diode), RF signal (such as Bluetooth, DECT (Digital Enhanced Cordless Telecommunications), DSRC (Dedicated Short Range Communications), HIPERLAN, HIPERMAN, IEEE 802.11, IrDA, RFID (Radio Frequency Identification), Ultra-wideband (UWB from WiMedia Alliance), WiFi, WiMAX, ZigBee, 3G, 3GPP, and Wireless USB), ultra-sonic signal, or any other operable electromagnetic signal. The rules of a game 60 and a machine readable program 70 may be stored on a local memory device or flash memory device or machine readable media such as magnetic disks, cards, tapes, and drums, punched cards and paper tapes, optical disks (DVD, CD), barcodes and magnetic ink characters or on a central or local server. The rules of a game 60 may be codified algorithmic elements, data charts, matrices, textual commands, time-based parameters, computer-language-based directives, or any other protocol that may provide for consistency and accuracy in generating, planning, conducting, monitoring, or viewing an online event.

The local server 90 may be a game console. The console 90 may be placed near a display 80 and may be oriented either horizontally or vertically. The front of the console 90 may feature a slot-loading media drive possibly illuminated by a light which may accept both 12 cm and 8 cm optical discs, for example from Nintendo's® prior console, the GameCube®. The Disc slot light may briefly illuminate when the console is turned on, when connected to a data service such as WiiConnect24 and when receiving new data, such as messages, and upon having selected “Bright” or “Dim” in the “Slot Illumination” settings for features such as WiiConnect24. The disc slot light may not stay illuminated during game play or when using other features of the console 90. Two or more USB ports may located at the rear of the console 90, and an SD card slot may hide behind a cover on the front of the console 90. Also, to utilize an SD slot, a software update may be downloaded, so game saves might not be transferred to or from a system which has not been connected to the internet. A console 90 may communicate with an online server 10 and send signal data 91 via either wireless or wired communications channels. Moreover, a console 90 may be connected to the world wide web 20 and may transfer digital information 92 thereto and therefrom. The console 90 may also communicate information 98 with a display 80 via either wired or wireless communications channels. In addition, a console 90 may also communicate with a sensor bar 82.

A display 80 such as a Liquid Crystal display (LCD), (LCD-based monitors can receive television and computer protocols (SVGA, DVI, PAL, SECAM, NTSC)), Cathode ray tube (CRT), Vector display, Plasma display, Surface-conduction electron-emitter display (SED), Video projector—implemented using LCD, CRT, Flat Panel, Rear projection, or other technologies such as Organic light-emitting diode (OLED) display may be provided. The display 80 may include, or be operable with a sensor bar 82.

Similar to a light gun, the remotes 30, 40, 50 may have light sensors, or other sensors, 32, 42, 52 that may allow the remotes to detect where each remote is pointing in relation to a monitor or display unit 80. Rather than using light from the screen itself, the remote 30, 40, 50 may also sense light from a sensor bar 82, allowing consistent usage regardless of the type or size of display unit or television 80. The sensor bar 82 may be about 20 cm in length and may feature ten infrared LEDs, with five LEDs being arranged at each end of the bar 82. The bar 82 may be placed above or below the monitor 80, and may optimally be centered. It is not necessary to point a remote directly at the sensor bar 82, but pointing significantly away from the sensor bar 82 may disrupt position-sensing ability possibly due to the limited viewing angle of remote 30, 40, 50. However, systems may be provided wherein multiple sensor bars 82 may be positioned in multiple locations around a room or area relative to a display 80 and may facilitate remote sensing wherein the remote 30, 40, 50 may be operably pointed in any direction. Such an orientation may be amenable to event views displayed in 3-D by a virtual helmet worn by a user. The use of a sensor bar 82 may allow a remote 30, 40, 50 to be used as an accurate pointing device up to 5 meters (approx. 16 ft) away from the bar. Sensor information may be communicated between a remote 30, 40, 50 in the form of signal data 38, 48, 58. This sensor information may be available in addition to, and supplemented by, a 3-axis acceleration sensor(s) in the remote 30, 40, 50, providing six degrees of freedom in total. Rotation (roll) of the remote 30, 40, 50 around its major axis may also sensed by these accelerometers and may be used as tilt sensors relative to the constant force of gravity.

The remote also may feature an expansion port at the bottom which allows various functional attachments to be added to the controller. Additionally, the remote 30, 40, 50 may communicate with the console 90. The communications may be signal data 39, 49, 59 and may be transmitted through wireless protocol or via wires. The remote 30, 40, 50 may be in communication with other remotes 30, 40, 50 sending signal data 34, 45, 53 between remotes via either wireless transmissions or wired transmissions.

A Nunchuk controller peripheral, such as a controller made by Nintendo® may be operable with or attached to the main controller. The Nunchuk may connect to the Remote via a wire such as long cord or may be in wireless communication with the remote, and its appearance while attached may resemble the nunchaku. It may feature an analog stick similar to the one found on the Nintendo® GameCube® controller and may also include two or more trigger buttons. It may work in tandem with the main controller 30, 40 50 in many games. Like the Remote 30, 40, 50, the Nunchuk controller may also provide accelerometer(s) for three axis motion-sensing and tiltling, but may not include a speaker or rumbling features.

A Steering wheel controller may be used for certain games, such as Monster 4×4 World Circuit and GT Pro Series and other driving and racing games. The peripheral steering wheel, such as a steering wheel controller created by Thrustmaster, may be controlled by tilting the wheel forwards and backwards to shift gears. Other games may make use of this peripheral as well when using the same controls.

The position and motion tracking of the remote 30, 40, 50 may allow a user 36, 46, 56 to mimic actual game actions, such as swinging a tennis racket, driving a car or shooting a basket, instead of simply pushing buttons. Each sensor bar 82 and display unit 80 may be configured to communicate with a plurality of remotes 30, 40, 50 and/or online servers 10.

An embodiment of a Massive Multiplayer Online Sports Teams and/or Event may include detail as in FIG. 1, wherein numerated components are identified as follows:
10=online server
20=world wide web
21=communications between online server and world wide web
30=first remote
31=first data signals
32=first sensor
34=signal data communications between first remote and second remote
36=first user
37=first accelerometer
38=signal data communications between first remote and display
39=signal data communications between fist remote and console
40=second remote
41=second data signals
42=second sensor
44=second accelerometer
46=second user
45=signal data communications between second remote and third remote
48=signal data communications between second remote and display
49=signal data communications between second remote and console
50=third remote
51=third data signals
52=third sensor
53=signal data communications between third remote and first remote
56=third user
57=third accelerometer
58=signal data communications between third remote and display
59=signal data communications between third remote and console
60=rules of game or event
70=computer readable program
80=display
82=sensor bar
85=communications between display unit and online server
90=game console/local server
91=communications between console and online server
92=communications between console and world wide web
98=communications between console and display

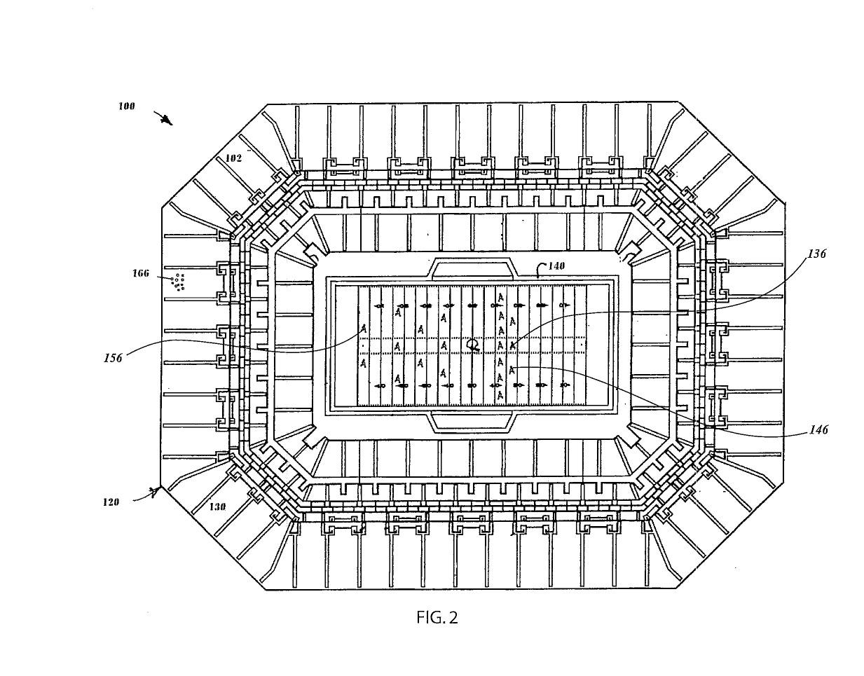

Embodiments of the present invention may include viewable images of an MMOSTE. For example, FIG. 2 depicts a view of an MMOSTE activity comprising a football game 100. The football game 100 may be played at a virtual stadium 120 located in an online virtual world. The stadium may include a sports field 140 and various seating sections 102, 130. During the football game 100 multiple users may maneuver remotes (such as remotes 30, 40, 50 of FIG. 1) to control players of various virtual teams. The players may be avatars or user controlled online embodiments of virtual athletes capable of participating in the football game 100. For instance, one user (actually located in Singapore) may utilize a remote 30 (see FIG. 1) to control a player 136 in the football game 100, while another user (actually located in France) may utilize another remote 40 (see also FIG. 1) to control another player, while yet a still different user (actually located in New York) may utilize a remote 50 (FIG. 1) to control a player 156, wherein the player 156 may be on an opposite team and competing against the team for which players 136 and 146 are playing. In this sense, users from anywhere in the world may combine together as a team of online connected players and compete in a single virtual location, such as the football stadium 120 in a football game 100 against another team of online connected players.

Spectators 160, or other online participants in the MMOSTE, may also enter the stadium 120 and may view the game 100. The view of the game may be provided from a perspective corresponding to a spectator's virtual location in the virtual stadium 120, or spectators may have capability to view the game from one or more perspective views. For example, the view depicted in FIG. 1 may be a view provided by a virtual blimp operable with the MMOSTE. Spectators 160 and/or players 136, 146, 156 may need special permissions to enter the virtual stadium area 120 of the MMOSTE and thereby view or participate in the football game 100. The special permissions may be granted according to governing protocol related to whether or not the users controlling the spectators 160 or players 136, 146, 156 have paid virtual or real monies to grant access therein. However, entrance into the stadium 120 may be given free access to all MMOSTE participants.

The players 136, 146, 156, of the football game 100 may be novice, amateur, or professional MMOSTE user athletes. To play the game 100, users control the players 136, 146, 156, through physical three-dimensional movement of remotes, such as remotes 30, 40, 50 depicted in FIG. 1. Certain users may develop acute proficiency in maneuvering the remotes to control players to throw, jump, pass, block, tackle, run, spin, juke and the like. Accordingly, highly proficient users may be accorded professional status, and be involved in online teams, divisions, leagues in highly competitive and very exciting/entertaining MMOSTE activities. As such, a stadium 120 may be constructed with modular parameters allow dozens to millions of spectators and/or player participants to view the game 100. Moreover, various advertising means, such as virtual online signs, billboards, posters, seat covers, flyers, banners, etc. may be available to MMOSTE participants. Furthermore, pop-up ads may be provided during the game. Still further, the game may include participant bands, cheerleaders, and half-time performances available for participant viewing and interaction.

Players 136, 146, 156 and/or spectators 160 may communicate with each other via chat functionality or via online A/V signal distribution. Hence, users may be able to see real life images of each other and hear each other as they may communicate through online means as related to parameters of the MMOSTE.

The game 100 may be governed by rules, such as rules 60 (see FIG. 1). The rules may closely mimic rules of real life games. For example, standard football rules may be applied to play of the football game 100 by the players 136, 146, 156. Furthermore, the game 100 may be officiated by computer program directed referees, or by real life users participating in the MMOSTE as officials. The officials may also use remotes, such as remotes 30, 40, 50, to throw flags and or otherwise maneuver the online embodiment of the referee. Rules 60, may include parameters corresponding to life-mimicking computer programmable attributes. For example, the game may include protocol to compensate for gravity, lighting (sunny, night-time, foggy) weather conditions (rain, snow, etc.) field conditions (grass turf, artificial turf), crowd noise (either computer generated, or generated in response to inputs provided by spectator 160 participants), and or other conditions typical to a real football game. The rules 60 may be executed by a single online server 10 or a bank or plurality of operatively linked servers, mainframe computers, personal computers and/or other computer program readable devices.

A console 90 may be portable having wireless communication capability. A display may also be portable and wireless. It is conceivable that users controlling players and/or spectators etc. may utilize portable devices to link to the world wide web and participate in MMOSTE activities using remotes, such as remotes 30, 40, 50 that may be operable with respect to the portable devices.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

What is claimed is:

1. A massive multiplayer online game or event comprising:
an online server connected to the world wide web;
a first remote having a first sensor to detect movement and orientation of a first user, wherein first data signals are communicated from said sensor to the online server;
a second remote having a second sensor to detect movement and orientation of a second user, wherein data signals are communicated from said sensor to the online server; and
a machine readable program with the rules of a game or event thereon to coordinate the first data signals and the second data signals in accordance with the rules of the game or event.

2. The invention of claim 1, wherein the first user and second user compete in a virtual sporting event or tournament using real world physical skills.

3. The invention of claim 2, wherein the sporting event or tournament is selected from the group consisting of: boxing, lacrosse, downhill skiing, tennis, table tennis, track events, sports car driving, golf, karate, ultimate fighting, motocross, soccer, basketball, baseball, wrestling, gladiator sports, air sports (hangglidding, helicopter, airplane) American football, badminton, Canadian football, cricket, curling, cycling, road bicycle racing, mountain bike racing, BMX, snowboarding, field Hockey, thoroughbred Horse racing, skateboarding, ice hockey, lacrosse, box/indoor lacrosse, mixed martial arts, rugby league, shooting, swimming, and triathlon.

4. The invention of claim 2, wherein a third user is a spectator that pays admission to the sporting event or game.

5. The invention of claim 1, wherein a third user is a spectator.

6. The invention of claim 1, wherein a user may purchase sporting equipment using virtual or real world currency.

7. A massive multiplayer online game or event comprising:
connecting at least 100 users to an online server connected to the world wide web;
providing a remote having a first sensor to detect movement and orientation of a first user, wherein first data signals are communicated from said sensor to the online server;
providing a remote having a second sensor to detect movement and orientation of a second user, wherein data signals are communicated from said sensor to the online server;
providing a rules of a game or event thereon to coordinate the first data signals and the second data signals in accordance with the rules of a game or event; and
competing, using physical skills, between the first and second user to generate the first data signals and second data signals to arrive at an outcome based on the rules of the game or event.
